(19) United States
(12) Patent Application Publication
(10) Pub. No.: US 2008/0278583 A1
(43) Pub. Date: Nov. 13, 2008

(54) Method and device for activating and deactivating a television set

(76) Inventor: Bradley J. Evenson, II, Las Vegas, NV (US)

Correspondence Address: WEISS & MOY PC, 4204 NORTH BROWN AVENUE, SCOTTSDALE, AZ, 85251, US

(21) Appl. No.: 11/800,514

(22) Filed: May 7, 2007

(51) Int. Cl. H04N 5/33

(52) U.S. Cl. 348/164

(57) ABSTRACT

A device to automatically activate and deactivate a television set has a sensor. The sensor will monitor an area in front of the television set. A controller is coupled to the sensor. The controller will send signals to activate and deactivate the television set when the sensor monitors a presence or absence of an individual in front of the television set.

### BACKGROUND OF INVENTION

1. Field of Invention

The present invention relates to television sets, and more particularly to an apparatus and method which will automatically activate and deactivate a television set based on location of one or more individuals around the television set.

2. Description of Related Art

Presently, most televisions come with a remote control device. A remote control device allows for a user to control operation of the television set from a distance. In fact, many remote controls contain all the function controls of the television while the television itself only has a handful of essential primary control buttons. The remote control device allows a person to remain seated when controlling operations of the television set. Thus, the user of the remote control device does not have to get up from his/her seat and manually change the channel/volume/etc. from controls located on the television set.

While remote control devices do work for activating and deactivating the television, they have several drawbacks. First, the remote control devices tend to get misplaced. Thus, many times a person still has to go to the television to manually activate/deactivate the television. Second, the remote control device still requires the user to manually push buttons to control the television set. There is no automation with the remote control device. Third, any one may use the remote control to activate/deactivate the television. Many times, small children will use the remote to activate the television and then set directly in front of the television screen.

Therefore, it would be desirable to provide an apparatus and method that overcomes the above problem. The apparatus and method will automatically activate and deactivate a television set based on location of individuals around the television set.

### SUMMARY OF INVENTION

In accordance with one embodiment of the present invention, a device to automatically activate and deactivate a television set is disclosed. The device has a sensor. The sensor will monitor an area in front of the television set. A controller is coupled to the sensor. The controller will send signals to activate and deactivate the television set when the sensor monitors a presence or absence of an individual in front of the television set.

In accordance with one embodiment of the present invention, a method to automatically activate and deactivate a television set is disclosed. The method comprises: providing a sensor for monitoring an area in front of the television set; and sending signals from the sensor to activate and deactivate the television set when the sensor monitors a presence or absence of an individual in front of the television set.

The foregoing and other objects, features, and advantages of the invention will be apparent from the following, more particular, description of the preferred embodiments of the invention, as illustrated in the accompanying drawing.

### BRIEF DESCRIPTION OF DRAWINGS

The present invention will become more fully understood from the detailed description and the accompanying drawings, wherein:

FIG. 1 is a front view of a television set with the control device of the present invention.

FIG. 2 is a perspective view of the control device depicted in FIG. 1.

FIG. 3 is a front view of a television set with the control device of the present invention built into the television set.

FIG. 4 is a perspective view of the control device depicted in FIG. 3.

FIG. 5 is a simplified block diagram of one embodiment of the control device of the present invention.

FIG. 6 is a simplified block diagram of a second embodiment of the control device of the present invention.

Common reference numerals are used throughout the drawings and detailed description to indicate like elements.

### DETAILED DESCRIPTION

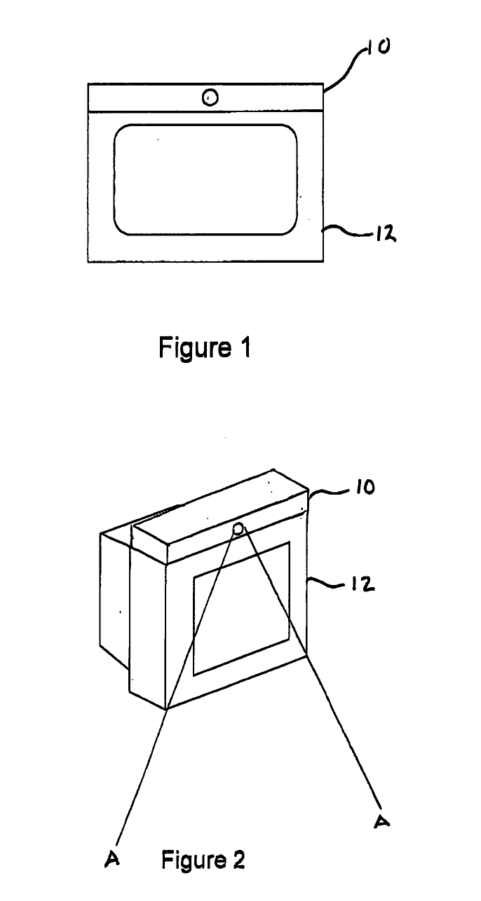

Referring to FIGS. 1-4, a control device 10 is shown. The control device 10 may be a stand alone unit which may be added to an existing television set 12. As shown in FIGS. 1 and 2, the control device 10 is a stand alone unit which is placed on a top surface of a television set 12. The control device 10 may be positioned in other locations without departing from the spirit and scope of the present invention. In general, the control device 10 should be positioned so as to be able to scan an area out in front of the television set 12.

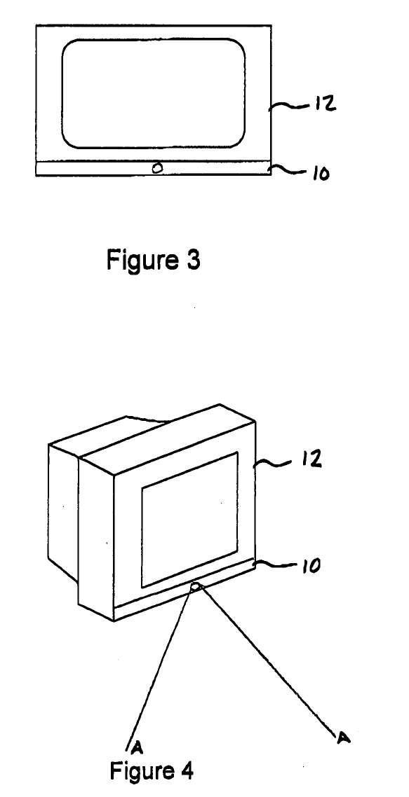

Alternatively, as shown in FIGS. 3 and 4, the control device 10 may be built-in to the television set 12. As shown in FIG. 2, the control device 10 is built into the television set 12 and is located in a bottom front area of the television set 12. However, the control device 10 may be positioned in other locations in the television set 12 without departing from the spirit and scope of the present invention. As stated above, in general, the control device 10 should be positioned so as to scan an area out in front of the television set 12.

The control device 10 is used to automatically activate or deactivate the television set 12. The control device 10 works by monitoring an area around the television set 12 as shown by the lines A-A of FIGS. 2 and 4. In general, the control device 10 will monitor an area in front of the television set 12 and will activate/deactivate the television set 12 based on whether the control device 10 detects a person in the area A-A in front of the television set or not.

The control device 10 can work in several different manners. In accordance with one embodiment of the present invention, the control device 10 is used to prevent children from sitting to close when watching the television set 12. The control device 10 will deactivate the television set 12 if a child gets to close to the screen of the television set 12. The control device 10 will activate the television set 12 once the child moves away from the screen and is positioned at a safe distance to view the television set 12.

In accordance with another embodiment of the present invention, the control device 10 is used to automatically activate and deactivate the television set 12. The control device 10 will activate the television set 12 when the control device 10 detects a person is position in front of the television set 12. The control device 10 will deactivate the television set 12 once the person moves away from the television set 12. This mode is useful for older individuals who would like the television set 12 to automatically turn once they sit in front of the television set 12 and turn off once they leave.

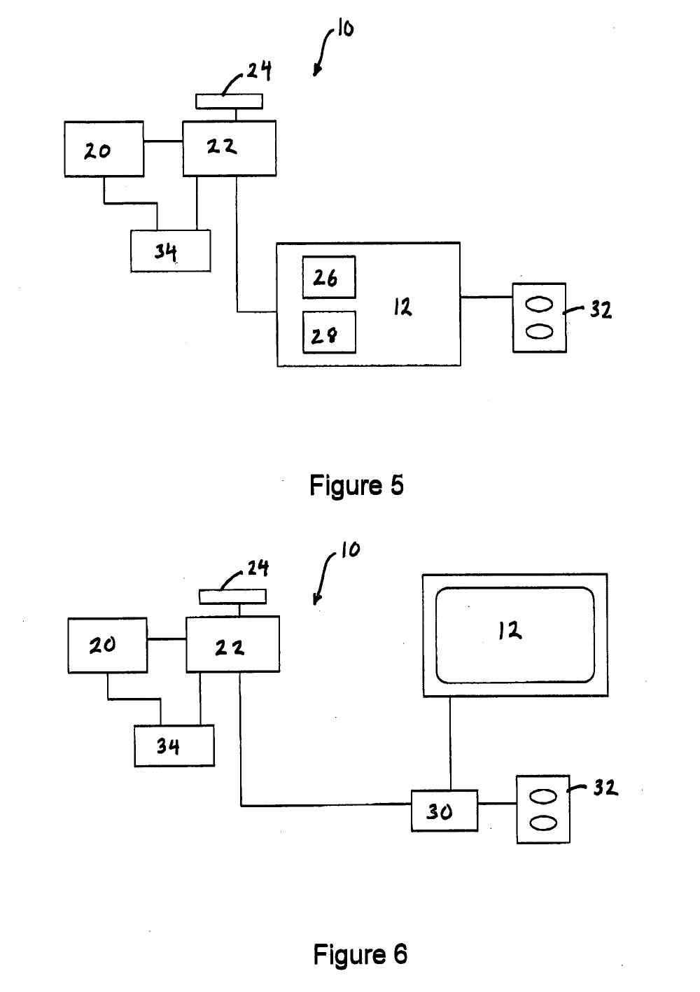

Referring to FIG. 5, a simplified functional block diagram of the control device 10 is shown. The control device 10 will have a sensor 20. The sensor 20 is used to monitor the area around the television set 12. The sensor 20 may be a motion sensor, infrared detector, heat sensor, and the like. The listing of the above is given as an example. Other types of sensors may be used without departing from the spirit and scope of the present invention. The sensor 20 may be movable so as to direct the sensor 20 to a particular area to be monitored.

The sensor 20 is coupled to a controller 22. The sensor 20 sends monitoring signals to the controller 22. Based on the signals received from the sensor 20, the controller 22 will send a signal to activate or deactivate the television set 12. The controller 22 will have a plurality of control buttons 24. The control buttons 24 are used to control the operation of the control device 10. The control buttons 24 may be used to turn the control device 10 on and off. The control buttons 24 may also be used to switch between operation modes (i.e., to prevent children from sitting to close to the television set 12 or to automatically activate/deactivate the television set based on the sensor 20 detecting a person in front of the television set.). The control buttons 24 may further be used to set the range of the sensor 20. For example, if the control device 10 is set to automatically activate/deactivate the television set based on the sensor 20 detecting a person in front of the television set 12, the sensor 20 may be set to a longer range to detect people further away from the television set 12. The listing of the above control buttons 24 are given as examples. Other control features may be used without departing from the spirit and scope of the present invention.

As stated above, based on the signals received from the sensor 20, the controller 22 will send a signal to activate or deactivate the television set 12. In accordance with one embodiment of the present invention, the controller 22 is directly coupled to the television set 12. The controller 22 may be coupled to a power unit 26 of the television set 12, the on/off switching unit of the television set 12, or other component of the television set 12 which will allow the controller 22 to activate and deactivate the television set 12. The controller 22 will send signals to the power unit 26, the on/off switching unit 28, and/or other components of the television set 12 which will allow the controller 22 to activate and deactivate the television set 12 (hereinafter power unit 26). The signals from the controller 22 will allow the power unit 26 to either activate or deactivate the television set 12 based on the signals received from the sensor 20. Thus in mode 1 wherein the control device 10 is used to prevent children from sitting to close when watching the television set 12, when the sensor 20 detects a child sitting too close to the television set 12, the sensor 20 will send a signal to the controller 22 which will send a signal to the power unit 26 to deactivate the television set 12. When the child moves away from the screen and is positioned at a safe distance to view the television set 12, the sensor 20 will send a signal to the controller 22 which will send a signal to the power unit 26 to activate the television set 12.

In mode 2 wherein the control device 10 is used to automatically activate and deactivate the television set 12 when the control device 10 detects a person is position in front of the television set 12, when the sensor 20 detects a person in front of the television set 12, the sensor 20 will send a signal to the controller 22 which will send a signal to the power unit 26 to activate the television set 12. When the person moves away from the television set 12, the sensor 20 will send a signal to the controller 22 which will send a signal to the power unit 26 to deactivate the television set 12.

Alternatively, as shown in FIG. 6 the controller 22 may be coupled to a switching device 30. The switching device 30 is also coupled to a power outlet 32. The television set 12 would be coupled to the switching device 30. The controller 22 will send signals to the switching device 30 which will either send power from the outlet 30 to the television set 12 to activate the television set 12 or cut off power from the outlet 30 to the television set 12 to deactivate the television set 12.

In general, the device 10 will have a power supply 34. The power supply 34 is used to power the different components of the device 10. The power supply 34 maybe an individual power supply located in the device 10. Alternatively, the power supply 34 may be an external power supply such as from the power outlet 32.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A device to automatically activate and deactivate a television set comprising:
a sensor for monitoring an area in front of the television set; and
a controller coupled to the sensor, the controller sending signals to activate and deactivate the television set when the sensor monitors a presence or absence of an individual in front of the television set.

2. A device to automatically activate and deactivate a television set in accordance with claim 1 wherein the controller is directly coupled to a power unit of the television set.

3. A device to automatically activate and deactivate a television set in accordance with claim 1 wherein the controller is directly coupled to an activation/deactivation unit of the television set.

4. A device to automatically activate and deactivate a television set in accordance with claim 1 further comprising a switching unit coupled to the controller, a power outlet and the television set, the switching device performing one of sending power from the power outlet to the television set to activate the television set or stopping power from the power outlet to the television set to deactivate the television set.

5. A device to automatically activate and deactivate a television set in accordance with claim 1 further comprising control buttons coupled to the controller to adjust operating parameters of the device.

6. A device to automatically activate and deactivate a television set in accordance with claim 1 wherein the sensor is a motion sensor.

7. A device to automatically activate and deactivate a television set in accordance with claim 1 wherein the sensor is an infrared sensor.

8. A device to automatically activate and deactivate a television set in accordance with claim 1 wherein the device is built in to a housing of the television set.

9. A device to automatically activate and deactivate a television set in accordance with claim 1 wherein the device is a stand alone unit.

10. A device to automatically activate and deactivate a television set comprising:
a sensor for monitoring an area in front of the television set;
a controller coupled to the sensor, the controller sending signals to activate and deactivate the television set when the sensor monitors a presence or absence of an individual in front of the television set;
a switching unit coupled to the controller, a power outlet and the television set, the switching device performing one of sending power from the power outlet to the television set to activate the television set or stopping power from the power outlet to the television set to deactivate the television set;
a power supply coupled to the sensor and the controller.

11. A device to automatically activate and deactivate a television set in accordance with claim 10 further comprising control buttons coupled to the controller to adjust operating parameters of the device.

12. A device to automatically activate and deactivate a television set in accordance with claim 10 wherein the sensor is a motion sensor.

13. A device to automatically activate and deactivate a television set in accordance with claim 10 wherein the sensor is an infrared sensor.

14. A device to automatically activate and deactivate a television set in accordance with claim 10 wherein the device is built in to a housing of the television set.

15. A device to automatically activate and deactivate a television set in accordance with claim 10 wherein the device is built in to a housing of the television set.

16. A method to automatically activate and deactivate a television set comprising:
providing a sensor for monitoring an area in front of the television set; and
sending signals from the sensor to activate and deactivate the television set when the sensor monitors a presence or absence of an individual in front of the television set.

17. The method of claim 16 further comprising providing a controller coupled to the sensor, the controller sending signals to activate and deactivate the television set when the sensor monitors a presence or absence of an individual in front of the television set.

18. The method of claim 17 further comprising directly coupling the controller to an activation/deactivation unit of the television set.

19. The method of claim 17 further comprising directly coupling the controller to a power unit of the television set.

20. The method of claim 16 further comprising providing a switching unit coupled to the controller, a power outlet and the television set, the switching device performing one of sending power from the power outlet to the television set to activate the television set or stopping power from the power outlet to the television set to deactivate the television set.
